(19) United States
(12) Patent Application Publication
(10) Pub. No.: US 2008/0116402 A1
(43) Pub. Date: May 22, 2008

(54) METHOD AND A DEVICE FOR MEASUREMENT OF SCATTERED RADIATION AT AN OPTICAL SYSTEM

(75) Inventor: Wolfgang Emer, Aalen (DE)

Correspondence Address: FISH & RICHARDSON PC, P.O. BOX 1022, MINNEAPOLIS, MN, 55440-1022, US

(73) Assignee: CARL ZEISS SMT AG, Oberkochen (DE)

(21) Appl. No.: 11/943,722

(22) Filed: Nov. 21, 2007

(30) Foreign Application Priority Data
Nov. 22, 2006 (DE) 10 2006 055 071.4

(51) Int. Cl. G01N 21/47

(52) U.S. Cl. 250/574

(57) ABSTRACT

Method and devices for measurement of scattered radiation at an optical system are disclosed. The methods can include: emitting radiation with a radiation source; passing the radiation from the radiation source through a first mask having locally varied transmission; passing the radiation from the first mask through the optical system; passing the radiation from the optical system through a second mask having locally varied transmission; measuring the intensity of the radiation having passed through the second mask with a locally resolving detector; and processing the local intensity distribution, determined by the detector, into a pupil resolved measurement result of scattered radiation.

### CROSS-REFERENCE TO RELATED APPLICATION

This application claims priority under 35 U.S.C. §119 to German patent application serial number 10 2006 055 071.4, filed Nov. 22, 2006, which is hereby incorporated by reference.

### FIELD

The disclosure relates to a method for measurement of scattered radiation at an optical system, such as projection optics of an exposure tool for microlithography. The disclosure also relates to a device for measurement of scattered radiation at an optical system, such as projection optics of an exposure tool for microlithography, an exposure tool for microlithography with such a device, and a wafer stage for microlithography with such an exposure tool. In addition, the disclosure relates to the use of a known device at an exposure tool for microlithography for measurement of scattered radiation.

### BACKGROUND

The measurement of scattered radiation can be an important measurement method of systems for microlithography, in order to be able to qualify the associated optical system. The portion of scattered radiation for different scattering ranges can be determined by the so-called Kirk-test in known scattered radiation measurements at optical systems, wherein a layer of photoresist is irradiated by two inverse masks, and the result is subsequently inspected for scattered radiation in a subjective manner.

### SUMMARY

In one aspect, the disclosure provides a method that includes: passing radiation from a radiation source through a first mask having locally varied transmission; passing the radiation from the first mask through an optical system; passing the radiation from the optical system through a second mask having locally varied transmission; measuring an intensity of the radiation having passed through the second mask with a locally resolving detector; and evaluating the locally distributed intensity, determined by the detector, into a pupil resolved measurement result of scattered radiation.

In another aspect, the disclosure provides a method that includes: passing radiation from a radiation source through the first mask having locally varied transmission; passing the radiation from the first mask through an optical system; passing the radiation from the optical system through a second mask having locally varied transmission; measuring the intensity of the radiation having passed through the second mask with a locally resolving detector, wherein the second mask is moved relative to the first mask; and evaluating the locally distributed intensity, determined by the detector, into a measurement result of scattered radiation.

In a further aspect, the disclosure provides a method that includes performing a pupil resolved measurement of scattered radiation.

In an additional aspect, the disclosure provides a device that includes: a first mask having locally varied transmission configured to pass through radiation emitted by a radiation source, and to pass radiation through an optical system; a second mask having locally varied transmission configured to pass through the radiation from the optical system; a locally resolving detector configured to measure the intensity of the radiation having passed through the second mask; and an evaluation apparatus configured to evaluate the locally distributed intensity, determined by the detector, into a pupil resolved measurement result of scattered radiation.

In another aspect, the disclosure provides a device that includes: a first mask having locally varied transmission configured to pass through radiation emitted by a radiation source, and to pass through an optical system; a second mask having locally varied transmission configured to pass through the radiation from the optical system; a locally resolving detector configured to measure the intensity of the radiation having passed through the second mask; a movement apparatus configured to move the second mask relative to the first mask; and an evaluation apparatus configured to evaluate the locally distributed intensity determined by the detector into a measuring result of scattered radiation.

In a further aspect, the disclosure provides a device that includes: a first mask having locally varied transmission configured to pass through the radiation from the radiation source and through an optical system; a second mask having locally varied transmission configured to pass through the radiation from the optical system; and a locally resolving detector configured to measure the intensity of the radiation, having passed through the second mask in a measurement plane, where the measurement plane of the locally resolving detector is disposed in radiation direction behind the image plane of the optical system.

In an additional aspect, the disclosure provides a device that includes: an evaluation apparatus configured to perform a pupil resolved measurement of scattered radiation.

In another aspect, the disclosure provides a method that includes: using a device for wave front detection at an optical system of an exposure tool for microlithography for measurement of scattered radiation at the optical system of the exposure tool.

The disclosure can provide a method and a device for the measurement of scattered radiation, wherein the above mentioned disadvantages are overcome, and overall a particularly meaningful and also cost effective measurement of scattered radiation are possible.

In some embodiments, the disclosure provides a method for measurement of scattered radiation at an optical system, in particular an exposure tool for microlithography is provided which includes: emitting radiation with a radiation source; passing the radiation from a radiation source through a first mask having locally varied transmission; passing the radiation from a first mask through the optical system; passing the radiation from an optical system through a second mask having locally varied transmission; measuring the intensity of the radiation having passed through the second mask with a locally resolving detector; and evaluating or processing the locally distributed intensity, determined by the detector, into a pupil resolved measurement of scattered radiation.

In certain embodiments, the disclosure provides a method for measurement of scattered radiation at an optical system of an exposure tool for microlithography is provided which includes: emitting radiation with a radiation source; passing the radiation from the radiation source through the first mask having locally varied transmission; passing the radiation from the first mask through the optical system; passing the radiation from the optical system through a second mask having locally varied transmission; measuring the intensity of the radiation having passed through the second mask with a locally resolving detector, wherein the second mask is moved relative to the first mask; and evaluating the local intensity distribution, determined by the detector, into a measurement result of scattered radiation.

In some embodiments, the disclosure provides a method for measurement of scattered radiation at an optical system (e.g., an exposure tool for microlithography), wherein a pupil resolved measurement of scattered radiation is performed.

In certain embodiments, the disclosure provides a device for measurement of scattered radiation at an optical system (e.g., an exposure tool for microlithography is provided) that includes: a radiation source for emitting radiation; a first mask having locally varied transmission for passing through the radiation from the radiation source, and further through the optical system; a second mask, having locally varied transmission for passing through the radiation from the optical system; a locally resolving detector for measuring the intensity of the radiation having passed through the second mask; and an evaluation apparatus for evaluating the local intensity distribution, determined by the detector, into a pupil resolved measurement result of scattered radiation.

In some embodiments, the disclosure provides a device for measurement of scattered radiation at an optical system (e.g., an exposure tool for microlithography) that includes: a radiation source for emitting radiation; a first mask having locally varied transmission for passing through the radiation from the radiation source, and further through the optical system; a second mask having locally varied transmission for passing through the radiation from the optical system; a locally resolving detector for measuring the intensity of the radiation, having passed through the second mask; a moving apparatus for moving the second mask relative to the first mask; and an evaluation apparatus for evaluating the local intensity distribution determined by the detector into a measuring result of scattered radiation.

In certain embodiments, the disclosure provides a device for measurement of scattered radiation at an optical system (e.g., an exposure tool for microlithography) that includes: a radiation source for emitting radiation; a first mask having locally varied transmission for passing through the radiation from the radiation source, and further through the optical system; a second mask having locally varied transmission for passing through the radiation from the optical system; and a locally resolving detector for measuring the intensity of the radiation, having passed through the second mask in a measurement plane, wherein the measurement plane of the locally resolving detector is disposed in radiation direction behind the image plane of the optical system.

In some embodiments, the disclosure provides a device for measurement of scattered radiation at an optical system (e.g., an exposure tool for microlithography) and an evaluation apparatus which is configured to perform a pupil resolved measurement of scattered radiation.

In certain embodiments, the disclosure provides an exposure tool for microlithography that includes a device as described herein, and a wafer stage having such a device.

In some embodiments, the device is used for wave front detection at an optical system of an exposure tool for microlithography for measurement of scattered radiation at the optical system of the exposure tool.

Without wishing to be bound by theory, it is believed that it can be problematic in certain known systems and methods that there is no association of the detected scattered radiation with a position within the pupil of the optical system, so that the scattered radiation situation cannot be determined with respect to a certain angle on a wafer, irradiated by the optical system. According to the disclosure, it was furthermore recognized that an association of scattered radiation with a position within the pupil of an optical system or a pupil resolved processing of the measured scattered radiation constitutes an important variable for qualifying an optical system, in particular a scanner for microlithography. The disclosure provides that this variable can be determined via a pupil resolved measurement of scattered radiation. According to the disclosure, this measurement can be performed in particular by passing electromagnetic radiation from a radiation source through two masks, a first, so-called luff mask, at the optical system, and a second, so-called lee mask, at the optical system. Passing the radiation through the masks in this context means besides a pure transmission through a mask layer also the reflection of radiation at a reflection mask, as it is typical in particular for EUV radiation (extreme ultraviolet light). The masks each have a locally varied transmission. Subsequently, the radiation, which has passed through the second mask, can be determined with a locally resolving detector, and in a solution, the thus determined locally distributed intensity is processed into a pupil resolved measurement of scattered radiation.

According to the disclosure, a differentiation can be made with respect to the scattered radiation situation, e.g. between scattered radiation close to the axis and scattered radiation remote from the axis. While scattered radiation close to the axis is created through a multiple reflection at surfaces of the optical system, scattered radiation far from the axis is typically created through individual beam expansions. According to the disclosure, not only a pupil resolved measurement of scattered radiation is performed, but subsequently, conclusions can be made with respect to the quality of the optical system. Furthermore, reasons for deficient quality can be given, or respective countermeasures or adjustments, e.g. in the form of accordingly adapted production masks, can be initiated.

The measurement of the intensity of the radiation, which has passed through the second mask, can be performed in several areas with locally varied transmission, which illuminate the same pupil in the remote field, or in the image plane. The advantage can thus lie in a substantially higher intensity on the associated locally resolving detector, e.g. a CCD chip, and thus concurrent with a higher measurement precision and a lower susceptibility to local mask errors. Furthermore a scattering disk can be disposed between the radiation source and the first mask.

In some embodiments, during the measurement of the radiation, which has passed through the second mask via a locally resolving detector, the second mask is moved relative to the first mask. With such a relative movement between the first and the second mask during the measurement, a wave shaped scattered radiation intensity curve occurs, from which for the different locations of the pupil the respective minimum can be determined, and this way, a pupil resolved measurement of scattered radiation can be provided.

In certain embodiments, at least one mask is configured with a plurality of periodically disposed sections of varied transmission. The areas thus configured in particular as openings, or sections with locally varied transmission within the mask, can provide a high transmission difference, and thus allow large measurement ranges with a correspondingly high measurement precision. The plurality of the openings allow a widely distributed measurement in order to obtain a pupil resolved measurement of scattered radiation, which is as widely distributed as possible. The periodicity of the openings allows comparisons or conclusions between the measurements at the particular openings, so that a higher precision is achieved again, and the measurements are less sensitive with respect to local mask errors.

In some embodiments, the second mask is configured with a transmission structure, which is inverse to the first mask. Such a mask combination allows a particularly simple measurement of scattered radiation, since the information about the scattered radiation can be obtained alone by covering the image of the first mask through the image of the second mask. Furthermore, a calibration of the measurement is possible via a dark image.

With respect to the movement of the second mask relative to the first mask, in order to thereby determine the minimum of the scattered radiation intensity in a particularly precise manner, it can be advantageous to perform the relative movement in a first direction and a second direction, which is substantially perpendicular to the first direction. Thus, the second mask can be moved since its movement is possible in a simpler manner in case of a wafer stage with respect to the current state of the art. Via the locally resolving detector, thus two-dimensional intensity information can be measured, and accordingly conclusions can be made with respect to the scattered radiation situation at the optical system, which is being analyzed. The relative movement of the two masks can be performed like the phase shifting for a wave front sensor, as it can be disposed in known wafer stages. With such a wave front sensor, the wave front is reconstructed in the measurement plane from a large number of partial beams. Such a sensor can be used for measurement of scattered radiation by extracting also scattered radiation information via the locally resolving detector of the wave front sensor.

The scattered radiation information, and in particular the pupil resolved measurement result of scattered radiation can be obtained as described above, in particular by matching the masks, which are inverse as a matter of principle, so that a direct light passage does not occur anymore, and only scattered radiation can pass through the second mask. Via a movement of the masks relative to each other, similar to the phase shift of present wave front sensors, the minimum of the scattered radiation intensity can also be determined pupil resolved, this mechanism associated with the particular positions within the pupil, or a certain angle on an associated wafer.

In some embodiments, at least one mask is used, which has a periodic structure of locally varied transmissions, and during movement of the second mask, relative to the first mask, this movement is performed over several periods of the the structure. This procedure leads to a particularly precise measurement, which is mostly independent from local mask errors.

In certain embodiments, a procedure is provided in which the first mask, as well as the second mask includes a periodic structure with locally varied transmission, and both periodic structures have the same period. With such masks, a sine shaped signal shall be obtained with respect to the measured scattered radiation intensity, from which deviations can be detected in a particularly simple manner.

In certain embodiments, operation is done with a first and a second mask, wherein both include a periodic structure of locally varied transmission, wherein both periodic structures, however, have different pulse duty cycles. Such masks lead to a distorted sine signal, wherein the shape of the signal graph depends on the pulse duty cycles of both masks. Via different pulse duty cycles, conclusions can be made accordingly in a pupil resolved manner with respect to the quality of the optical system.

In some embodiments, the first and the second mask have a periodic structure of locally varied transmission, and the pulse duty cycle of at least one of the two masks is selected greater than one. This means that this mask has larger dark areas, than transparent areas. This way, it can be assured that, independent from smaller deviations in the relative position of the two masks in the covered state, only the scattered radiation contributes to the measured signal. Thus, which of the two masks has a higher pulse duty cycle, basically does not make a difference with respect to the yielded measurement results.

In certain embodiments, a locally resolving detector is disposed at the device, whose basic features have been described above, for measuring the intensity of the radiation, which has passed through the second mask, whose measuring plane is disposed in radiation direction behind the image plane, or the focusing plane of the optical system. The second mask can be disposed in such device in the image plane of the optical system. Via the detector, which is disposed in this manner, the angular direction of the scattered radiation can be determined, which passes through the second mask in the particular areas of locally varied transmission, and a pupil resolved measurement of scattered radiation can be accomplished in this manner.

In some embodiments, a known device can be used for wave front detection at the associated exposure tool for a measurement of scattered radiation at a wafer stage. Known devices for wave front detection particularly include devices for arranging the first mask and the second mask and a locally resolving detector, which is used for the actual measurement of scattered radiation. Known devices for wave front detection can facilitate a relative movement of two masks relative to each other. Scattered radiation information can be extracted with such an existent wave front sensor, which can be of decisive importance, such as when using EUV radiation (extreme ultraviolet radiation), since the question, if one has to install one or two locally resolving detectors on a wafer stage, can create a large difference there. An example of a device for wave front detection is an interferometer. Different types of interferometers can be used. Such interferometers include a PDI (point diffraction interferometer), a LDI (line diffraction interferometer), a LSI (lateral sheering interferometer), a SLSI (slit type lateral shearing interferometer), a CGLSI (cross grating lateral shearing interferometer), and a DLSI (double-grating lateral shearing interferometer).

The measurement of scattered radiation thereby achieved with the interferometer can be performed pupil resolved, whereby a differentiation can be made between the scattered radiation of rays proximal to the axis and the scattered radiation of rays remote from the axis. Furthermore, one or several masks with a plurality of periodically disposed regions of varied transmission (e.g., openings) can be used, which can have an inverse transmission structure. For improved determination of the minimum of the measured scattered radiation intensity, a relative movement of the two masks can be performed, wherein this movement can be performed in two directions. Masks with a periodic structure can be used, wherein the structures can have the same period and/or different pulse duty cycles, so that purely sine shaped or distorted sine shaped signals of the scattered radiation intensity can be created. Additionally, as already mentioned above, masks can be used, in which the pulse duty cycle of at least one of the masks is greater than one.

The locally resolving detector of the device can be furthermore provided with a point or line shape measuring sensor, and movement mechanism for moving the sensor in at least one direction.

### BRIEF DESCRIPTION OF THE FIGURES

The disclosure may be better understood based on the description below as well as the figures, in which:

FIG. 1 an illustration of the general layout for measurement of scattered radiation at an optical system in an exposure tool for microlithography;

FIG. 2 shows respective top views of three different masks of a device according to FIG. 1;

FIG. 3 is an illustration of a signal diagram of the intensity distribution at a device according to FIG. 1 with masks;

FIG. 4 is an illustration of a signal diagram of the intensity measurement at a device according to FIG. 1 with masks;

FIG. 5 is a highly schematic illustration of two signal diagrams of the intensity measurement at a device according to FIG. 1 with masks;

FIG. 6 a highly schematic illustration of two signal diagrams of the intensity measurement at a device according to FIG. 1 with masks;

FIG. 7 a part of the illustration according to FIG. 1, including an illustration of scattered radiation; and

FIG. 8 a part of the illustration according to FIG. 1, including an illustration of scattered radiation.

### DETAILED DESCRIPTION

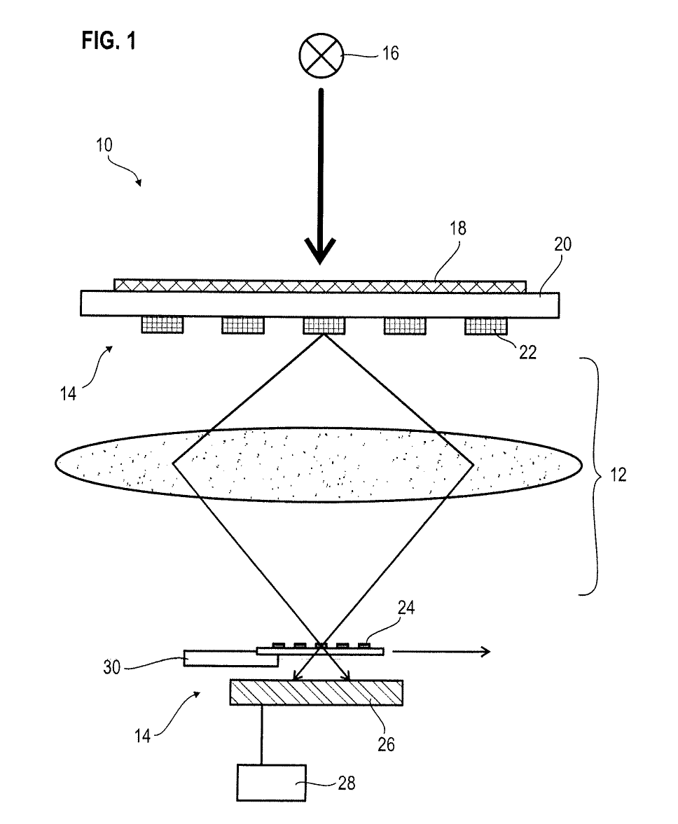

FIG. 1 illustrates an exposure tool 10 for microlithography, including an optical system 12, provided as projection optics. At the optical system 12 a device 14 for measuring scattered radiation is provided, which is created in the optical system 12, when it is provided with a radiation source 16 in the form of a light for electromagnetic radiation, in particular in the ultraviolet wavelength range.

The device 14 includes a scatter light disk 18, which is disposed in radiation direction behind the radiation source 16 in front of a reticle 20 and a first mask 22. The first mask 22 includes areas with locally varied transmission and it is disposed in radiation direction in front of the optical system 12, so that the radiation from the radiation source 16 is partially held off at the first mask 22, or shaded off, and only a fraction of the radiation enters the optical system 12 and passes through it. The radiation is projected from the optical system 12 onto an image plane, in which during the use of the exposure tool 10 a wafer is disposed. For the present case of a measurement of scattered radiation at the exposure tool 10, a second mask 24 is disposed in the image plane, thus in radiation direction behind the optical system 12, and another locally resolving detector 26 in the shape of a photoelectric detector, like e.g. a CCD detector is provided behind this mask.

The masks 22 and 24 and the detector 26 are thereby adapted to each other in a manner, such that a pupil resolved measurement of scattered radiation can be performed therewith. For this kind of scattered radiation measurement, in particular a particularly adapted evaluation apparatus 28 is connected to the detector 26, and furthermore, a movement apparatus 30 is provided, through which the second mask 24 can be moved relative to the first mask 22, and relative to the optical system 12, in the image plane in a first direction, and in particular also in a second direction perpendicular to the first direction.

The first mask 22 and the second mask 24, and the movement apparatus 30 are components of a device provided for wave front detection, provided at the exposure tool 10, wherein the evaluation apparatus 28 is configured to extract scatter radiation information from the signal of the detector 26. This is advantageous in particular, since no particular sensor has to be provided for such measurement of scattered radiation. In particular in exposure tools with EUV exposure, it can be of great importance, if one or two sensors have to be disposed on the wafer stage. As a device for wave front detection in particular interferometers are used, including two masks or grids, which form the first mask 22, and the second mask 24 in the present case, and in which furthermore the second mask can be moved for so-called phase shifting. This then forms an expansion of such interferometer measurement technique towards additional scattered radiation information from the two-dimensional intensity information measured by the detector. The scattered radiation information can thus be processed and analyzed, so that it is available pupil resolved, so that the determined scattered radiation can be associated with a position within the pupil of the optical system 12 and with a certain angle on the wafer, respectively.

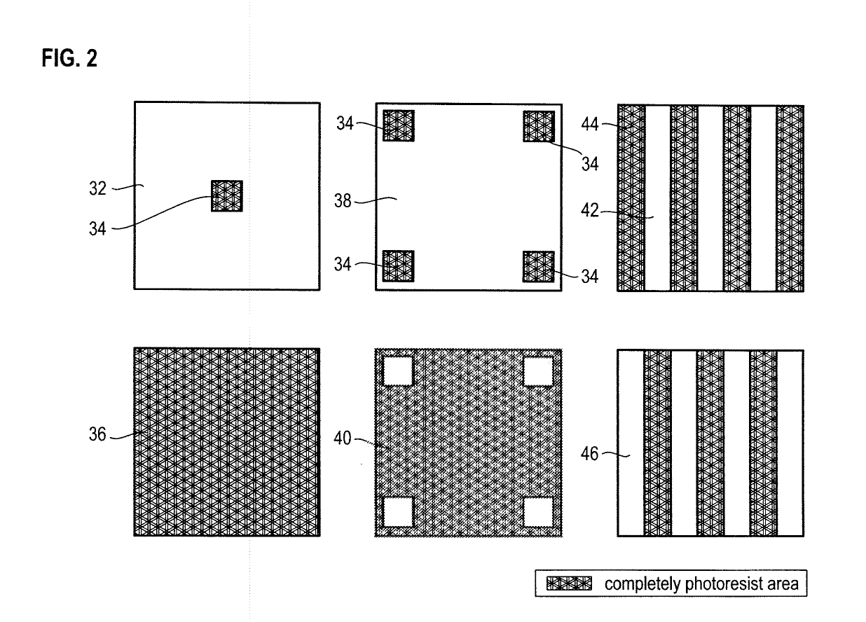

FIG. 2 shows two embodiments of first and second masks, which are used for the scattered radiation measurement. A first mask 32 includes a central pad 34, generating a shadowing of radiation in the middle of the mask 32. An associated second mask 36 includes a central opening corresponding to the pad 34, so that during a superposition of the two masks 32 and 36, a complete shadowing should occur. The complete shadowing can only be circumvented by scattered radiation or scattered light, which is created in the optical system 12. The intensity and the position of this scattered radiation is determined by moving the second mask 36 relative to the first mask 32, thus matching the pad 34 with the associated opening in the second mask 36. A sine shaped measurement curve is created, which reflects the intensity distribution determined by the detector 26.

The minimum of this measurement curve represents the intensity of scattered radiation at the measured pad 34. The flanks of the measurement curve allow a conclusion with respect to the type and the position of the scattered radiation within the pupil. Put differently, a minimum of the signal curve is yielded, when the luff image of the first mask 32 (which could also be designated as reticle grid) is centered relative to the second mask 36, (which could also be designated as wafer grid). The signal strength at this minimum can be processed and information is yielded with respect to the magnitude of the scattered radiation, and from the location of the measurement, also with respect to the type of scattered radiation. In configurations with a singular pad 34, a scattered radiation integral from a to infinity is obtained, wherein a is half the difference of the length of the edge of the transparent sector of the second mask 36 and the edge length of the dark section of the first mask 32.

FIG. 2 furthermore illustrates a first mask 38 and a second mask 40, in which overall four pads 34 are respectively disposed in the corner sections of the overall square masks. The pads 34 are disposed, so that they illuminate the same pupil in the far field on the measurement plane of the detector. The advantage is thus a much higher intensity at the detector 26 and thus an associated higher precision and a lower sensitivity with respect to local mask errors.

In another first mask 42, illustrated in FIG. 2 further on the right, the areas of locally varied transmission are configured with stripes 44 and an associated second mask 46 is configured with respectively configured stripes with an inverse transmission structure. The pads 34 were thus replaced here by a periodic structure, e.g. a line grid. This is close to a wave front interferometer.

In some embodiments, the movement is performed by a movement apparatus 30 over several phases of the periodic structure, via these masks 42 and 46, whereby the measurement precision can be further improved. With such periodic structures, a phase shifting curve is obtained as signal diagram, wherein in turn the minimum of this measurement curve includes the scattered radiation information. In the context of the measurement, thus the phase of the signal is less important, as it is the case with devices for wave front detection, however, the minimum or the minima of the measured intensity signal diagrams are more important.

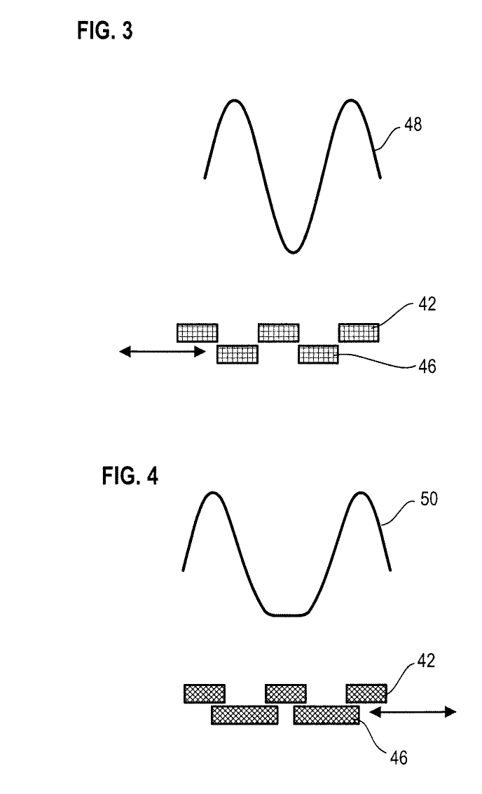

FIGS. 3 and 4 show signal diagrams 48 and 50 of measurements during the shift of a second mask 46 relative to a first mask 42. In case of FIG. 3, the masks 46 and 42 are masks with identical structure. With these masks 42 and 46, a sine shaped signal is obtained. FIG. 4 shows the signal diagram 50 in a combination of a first mask 42 with a second mask 46, wherein the masks include identical periods, but different pulse duty cycles. The different pulse duty cycles however lead to a “distorted” sine shaped signal.

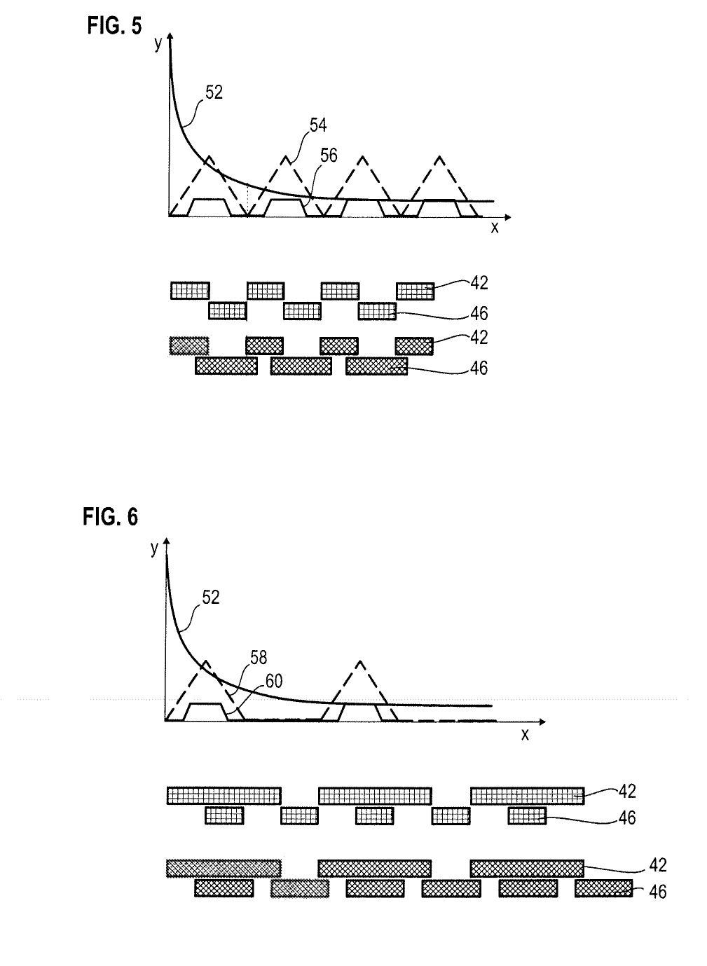

In FIGS. 5 and 6, respectively, the intensity of scattered radiation (Y-axis) over the range of the scattered radiation (X-axis) is illustrated. The scattered radiation at a location of the pupil is derived in the optical system 12, along a decreasing intensity distribution 52 of scattered radiation. For this purpose, the signal diagram of the intensity measurement with a detector 26 is shown in the diagrams according to FIGS. 5 and 6 respectively in a highly schematic manner. Different signal diagrams result, depending on the type of masks 42 and 46 used. A first signal diagram 54 is reached for masks having identical periods and identical pulse duty cycles. A second signal diagram 56 is created for masks having identical periods and different pulse duty cycles. The signal diagrams are also periodic, due to the periodic structures of the masks used, wherein the nulls are generated by multiples of the period. The areas between the nulls are trapezoid, and the shape of the trapezium depends on the pulse duty cycles of the masks used. It is recommended to select the pulse duty cycle of one of the masks larger than one; this means the mask has larger darker sections, than transparent ones. This way, it can be assured that independent from the position of the masks relative to each other, only scattered radiation contributes to a signal.

FIG. 6 shows highly schematic signal diagrams 58 and 60, in which the first mask 42 has been respectively configured with another pulse duty cycle, than the one of FIG. 5. It becomes apparent, that the scattered radiation intensity distribution 52 accordingly leads to measurement results, which can be evaluated, at longer minima sections of the intensity distributions 58 or 60.

FIGS. 5 and 6 furthermore illustrate, how an unfolding of the scattered radiation integrals is possible via the particular minima measurements at the signal distributions 54 to 60, so that a range resolved information regarding the scattered radiation or the scattered light can be extracted there from. The measured intensities at the particular minima of the signal diagrams 54 to 60 can thus be compared to a basically expected scattered radiation intensity distribution (e.g. the intensity distribution 52 of scattered radiation) and conclusions with respect to the actually present scattered radiation situation at the optical system 12 can be drawn from the determined deviation.

Through the strong decrease of the scattered radiation intensity distribution 52 towards higher ranges of the scattered radiation, the periodicity of the detected area can only play a secondary role; this means the signal strength is dominated by ranges of the scattered radiation of less than one period. In order to avoid such problems, in particular during a scattered radiation measurement, a movement of various combinations of masks 42 and 46 is performed relative to each other. This movement can be performed sequentially, or the different masks are disposed next to each other, or parallel to each other, so that at different pupils (so-called Rois) signals from different mask combinations would be obtained. FIG. 5 thus illustrates two signal diagrams 54 and 56 in a highly schematic manner, wherein in case of the signal diagram 54 the masks 42 and 46 include identical periods and identical pulse duty cycles, and in case of the signal diagram 56 the masks 42 and 46 include identical periods and different pulse duty cycles. FIG. 6 shows two signal diagrams 58 and 60 in a highly schematic manner, in which the mask in comparison to FIG. 5 includes a changed period and a changed pulse duty cycle.

When processing the signal diagrams 54 through 60, determined during the movement, a signal minimum is determined separately for the particular local sections of the detector 26, and in particular for each of its pixels. This signal minimum then yields a pupil resolved measurement result of scattered radiation, which can be calibrated through a dark image if necessary. Furthermore, the intensity over the entire pupil can be determined through an integration of the scattered radiation information, wherein according to requirements, also a weighting of particular pupil sections is possible.

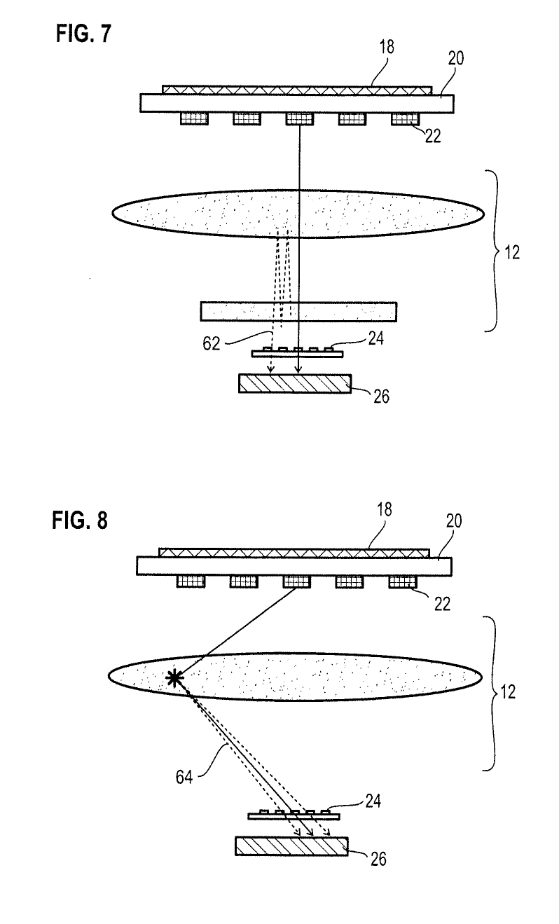

In FIGS. 7 and 8, the differentiation, which is possible between different types of scattered radiation at the optical system 12, is illustrated. FIG. 7 shows the situation with a scattered radiation 62, which occurs only for radiation very proximal to the axis through multiple reflections with reference to the axis of the optical system 12. This scattered radiation 62 proximal to the axis passes along the mask 46 through a transparent area, which in the present case, is removed by more than one period from the area shadowing the primary radiation. In the situation according to FIG. 8, scattered radiation at the rim of the pupil occurs through fanning. This leads to the scattered radiation remote from the axis passing through those transparent areas, which are directly adjacent to the area shadowing the primary radiation. The differentiation of various types of scattered radiation 62 or 64, thus accomplished was not possible with methods known so far.

Other embodiments are in the claims.

### DESIGNATIONS

10 exposure tool

12 optical system

14 device for scattered radiation measurement

16 radiation source

18 scatter disk

20 reticle

22 first mask

24 second mask

26 detector

28 evaluation apparatus

30 movement apparatus

32 first mask

34 pad

36 second mask

38 first mask

40 second mask

42 first mask

44 stripe

46 second mask

48 signal diagram with identical periods and identical pulse duty cycles

50 signal diagram with identical periods and different pulse duty cycles

52 intensity distribution of scattered radiation

54 highly schematic signal diagram with identical periods and identical pulse duty cycles

56 highly schematic signal diagram with identical periods and different pulse duty cycles

58 highly schematic signal diagram with changed period at the first mask

60 highly schematic signal diagram with changed period at the first mask

62 scattered radiation proximal to the axis

64 scattered radiation remote from the axis

What is claimed is:

1. A method, comprising:
passing radiation from a radiation source through a first mask having locally varied transmission;
passing the radiation from the first mask through an optical system;
passing the radiation from the optical system through a second mask having locally varied transmission;
measuring an intensity of the radiation having passed through the second mask with a locally resolving detector; and
evaluating the locally distributed intensity, determined by the detector, into a pupil resolved measurement result of scattered radiation.

2. The method according to claim 1, wherein at least one of the masks is configured with a plurality of periodically disposed areas of varied transmission.

3. The method according to claim 1, wherein the second mask is configured with a transmission structure, which is inverse with respect to the first mask.

4. A method, comprising:
passing radiation from a radiation source through the first mask having locally varied transmission;
passing the radiation from the first mask through an optical system;
passing the radiation from the optical system through a second mask having locally varied transmission;
measuring the intensity of the radiation having passed through the second mask with a locally resolving detector, wherein the second mask is moved relative to the first mask; and
evaluating the locally distributed intensity, determined by the detector, into a measurement result of scattered radiation.

5. The method according to claim 4, wherein during moving of the second mask relative to the first mask, the movement is performed in a first direction and in a second direction, which is substantially perpendicular to the first direction.

6. The method according to claim 4, wherein at least one mask comprises a periodic structure of locally varied transmission, and the movement is performed over several periods of the structure.

7. The method according to claim 6, wherein the first and the second mask comprise a periodic structure of locally varied transmission, and both periodic structures comprise the same period.

8. The method according to claim 6, wherein the first and the second mask comprise a periodic structure of locally varied transmission, and both periodic structures comprise different pulse duty factors.

9. The method according to claim 6, wherein the first and the second mask comprise a periodic structure of locally varied transmission, and the pulse duty factor of at least one of the masks is greater than one.

10. The method according to claim 1, wherein the steps are performed at an optical system of an exposure tool for microlithography.

11. A method, comprising: performing a pupil resolved measurement of scattered radiation.

12. A device, comprising:
a first mask having locally varied transmission configured to pass through radiation emitted by a radiation source, and to pass radiation through an optical system;
a second mask having locally varied transmission configured to pass through the radiation from the optical system;
a locally resolving detector configured to measure the intensity of the radiation having passed through the second mask; and
an evaluation apparatus configured to evaluate the locally distributed intensity, determined by the detector, into a pupil resolved measurement result of scattered radiation.

13. The device according to claim 12, wherein at least one of the masks is provided with a plurality of periodically arranged areas of varied transmission.

14. The device according to claim 12, wherein the second mask is provided with a transmission structure, which is inverse with respect to the first mask.

15. A device, comprising:
a first mask having locally varied transmission configured to pass through radiation emitted by a radiation source, and to pass through an optical system;
a second mask having locally varied transmission configured to pass through the radiation from the optical system;
a locally resolving detector configured to measure the intensity of the radiation having passed through the second mask;
a movement apparatus configured to move the second mask relative to the first mask; and
an evaluation apparatus configured to evaluate the locally distributed intensity determined by the detector into a measuring result of scattered radiation.

16. The device according to claim 15, wherein the moving apparatus configured to move the second mask relative to the first mask is configured to perform the movement in a first direction and a second direction, which is substantially perpendicular to the first direction.

17. The device according to claim 15, wherein at least one mask comprises a periodic structure with locally varied transmission, and the moving apparatus is configured to perform the movement over several periods of the structure.

18. The device according to claim 17, wherein the first and the second mask comprise a periodic structure of locally varied transmission, and both periodic structures comprise the same period.

19. The device according to claim 17, wherein the first and the second mask comprise a periodic structure having locally varied transmission, and both periodic structures comprise different pulse duty factors.

20. The device according to claim 17, wherein the first and the second mask comprise a periodic structure having locally varied transmission, and the pulse duty factor of at least one of the masks is greater than one.

21. A device, comprising:
a first mask having locally varied transmission configured to pass through the radiation from the radiation source and through an optical system;
a second mask having locally varied transmission configured to pass through the radiation from the optical system; and
a locally resolving detector configured to measure the intensity of the radiation, having passed through the second mask in a measurement plane,
wherein the measurement plane of the locally resolving detector is disposed in radiation direction behind the image plane of the optical system.

22. The device according to claim 21, wherein the locally resolving detector is provided with a dot or line shape measuring sensor and a movement apparatus for moving the sensor in at least one direction.

23. The device according to claim 21, wherein the optical system is associated with an exposure system for microlithography.

24. A device, comprising:
an evaluation apparatus configured to perform a pupil resolved measurement of scattered radiation.

25. An exposure system for microlithography comprising the device according to claim 12.

26. A wafer stage comprising the device according to claim 12.

27. A method, comprising:
using a device for wave front detection at an optical system of an exposure tool for microlithography for measurement of scattered radiation at the optical system of the exposure tool.

28. The method according to claim 27, wherein the measurement of scattered radiation is performed pupil resolved.

29. The method according to claim 27, wherein a first mask and/or a second mask having a plurality of periodically disposed areas of varied transmission is used.

30. The method according to claim 29, wherein a second mask having a transmission structure, inverse to the first mask, is being used.

31. The method according to claim 27, wherein a first and a second mask are used, and the second mask is moved relative to the first mask during the measurement of scattered radiation.

32. The method according to claim 31, wherein the movement of the first mask relative to the second mask is performed in a first direction and in a second direction, which is substantially perpendicular to the first direction.

33. The method according to claim 31, wherein the first and the second mask comprise a structure of periodically disposed areas of varied transmission, and the movement of the first mask relative to the second mask is performed through several periods of the structure of the periodically disposed areas of varied transmission.

34. The method according to claim 29, wherein the first and the second mask comprise a structure of periodically disposed areas of varied transmission, and both structures comprise the same period.

35. The method according to claim 29, wherein the first and the second mask comprise a structure of periodically disposed areas of varied transmission, and both structures comprise different pulse duty factors.

36. The method according to claim 29, wherein the first and the second mask comprise a structure of periodically disposed areas of varied transmission, and the pulse duty factor of at least one of the masks is greater than one.
